(19) United States
(12) Patent Application Publication
(10) Pub. No.: US 2009/0229199 A1
(43) Pub. Date: Sep. 17, 2009

(54) Building structure with having spaces having improved temperature stability

(75) Inventors: Van B. Krzywicki, Glen Spey, NY (US); Kathleen R. Lugosch, Amherst, MA (US); Mark G. Rittle, Sturgeon Bay, WI (US)

Correspondence Address: RYAN KROMHOLZ & MANION, S.C., POST OFFICE BOX 26618, MILWAUKEE, WI, 53226, US

(73) Assignee: PeaPod Homes, LLC

(21) Appl. No.: 12/381,284

(22) Filed: Mar. 10, 2009

Related U.S. Application Data
(60) Provisional application No. 61/068,875, filed on Mar. 10, 2008.

(51) Int. Cl. E04B 1/70; E02D 19/00; E04F 10/00; E06B 3/30; E04C 3/12; E04B 1/00; E04C 2/34

(52) U.S. Cl. 52/169.5; 52/302.1; 52/199; 160/19; 52/204.5; 52/847; 52/745.05; 52/794.1

(57) ABSTRACT

A structure according to the present invention provides spaces having improved temperature stability. The structure may be modular in nature and, when assembled, provides a gas circulation path comprised of a plurality of fluid flow ducts. Circulation of gas through the path may occur by way of natural convection and/or forced air assistance. A structure according to the present invention includes a thermal mass which contacts at least a portion of the gas circulation path. The thermal mass may provide structural support while providing the thermal retention to warm a portion of the circulation path.

### RELATED APPLICATIONS

This application claims the benefit of U.S. Provisional Patent Application Ser. No. 61/068,875, filed 10 Mar. 2008, and entitled “Building Structure With Spaces Having Improved Temperature Stability,” which is incorporated herein by reference in its entirety.

### BACKGROUND OF THE INVENTION

The present invention relates generally to building structures and more specifically to structures requiring less consumption of energy for maintaining desirable temperatures.

Energy conservation is, without question, desirable. In prior structures, such as houses, significant energy was consumed in maintaining living spaces at a comfortable temperature, while the ambient air temperature outside the structure may vary considerably. Prior solutions have been attempted at reducing energy costs, such as the superinsulation of the walls of a structure. Also, separate from superinsulation, other prior structures have been built as a double envelope, or a structure within a structure, to take advantage of a buffer air space between the two walls of construction. The primary purpose of either prior effort was to increase the R-value of the prior structure wall and/or roof members.

While an increase in R-value, in effect a greater insulation buffer, may improve the energy efficiency of a building structure, there remains room for improvement in the field for integrated structures having spaces with improved temperature stability.

### SUMMARY OF THE INVENTION

The present invention provides a building structure with spaces having improved temperature stability. A preferred embodiment of the invention provides a superinsulated, at least partial double envelope structure utilizing a thermal mass, preferably of wood, in contact with a fluid flow path, with pipes or other fluid chambers provided under the top of the lowest floor, to complete the path.

A building structure according to the present invention includes a basement structure including a basement space, a first floor structure including a first floor space, the first floor structure being at least partially supported by the basement structure, a roof structure at least partially supported by the first floor structure, and a fluid flow path extending beneath and through the basement space, through the first floor space, and below at least a portion of the roof structure. The fluid flow path may be selectively placed in and out of fluid communication with the first floor space.

The basement structure may comprise at least one insulated concrete foundation (ICF) wall that extends around at least a majority of the basement space. The basement space may further include a basement front end, a basement back end, and a basement height, and the basement structure may further include a basement floor, which may comprise a poured concrete floor, including a basement floor surface extending between a majority of the distance between the basement front end and the basement back end. The basement height extends substantially perpendicular to the basement floor. The basement structure may also include at least one fluid passageway extending beneath the basement floor surface between the basement front end and the basement back end.

The basement structure may further include a portion of the fluid flow path including a first fluid flow duct extending through the basement height, where the first fluid flow duct is located closer to the basement back end than to the basement front end. The basement structure may also include a second fluid flow duct extending through the basement height, where the second fluid flow duct is located closer to the basement front end than to the basement back end. The first fluid flow duct and the second fluid flow duct are at least substantially fluidly noncommunicative through the basement space. Also, the first fluid flow duct and the second fluid flow duct are in fluid communication through the at least one fluid passageway.

The first floor structure of an embodiment according to the present invention may further comprise at least one structural insulated panel (SIP) wall that extends around a majority of the first floor space. The first floor space includes a first floor front end, a first floor back end and a first floor height. The first floor structure also includes a fenestration at the first floor front end including a plurality of first floor front end windows. The first floor structure may also include a fifth fluid flow duct extending through the first floor height, the fifth fluid flow duct being located closer to the first floor back end than to the first floor front end. A sixth fluid flow duct may extend through the first floor height, the sixth fluid flow duct being located adjacent the first floor front end windows. At least a portion of the sixth fluid flow duct is at least partially lined with a thermal mass material which may comprise wood, such as southern yellow pine wood glue laminated logs. Each of said logs may have a cross-sectional area of about thirty-six square inches. The fifth fluid flow duct and the sixth fluid flow duct are at least substantially fluidly noncommunicative through the first floor space. Also, the fifth fluid flow duct and the first fluid flow duct are in fluid communication, and the sixth fluid flow duct and the second fluid flow duct are in fluid communication. The fifth fluid flow duct may be selectively placed in and out of the fluid communication with the first floor space, and an electric fan may be positioned inline with the fluid communication between the fifth fluid flow duct and the first floor space, adapted to draw air from the fifth fluid flow duct and blow the air into the first floor space.

The roof structure may comprise at least one structural insulated panel (SIP), which at least partially defines an attic space, wherein the fifth fluid flow duct and the sixth fluid flow duct are in fluid communication through the attic space. At least one fire damper may be disposed between the fifth fluid flow duct and the sixth fluid flow duct.

A building structure according to the present invention may further comprise a sunshade extending from an external wall of the first floor structure, above the windows. The sunshade may be adapted to obstruct a majority of sunlight that strikes said sunshade during a first portion of a calendar year, such as summer, and may be further adapted to obstruct a minority of sunlight that strikes said sunshade during a second portion of a calendar year, such as winter.

The windows included in the building structure may comprise glazings having a U factor of less than or about 0.290. At least one of the South facing windows may include a U factor of less than or about 0.266, a solar heat gain coefficient of greater than or about 0.634, a solar transmittance of greater than or about 0.621, and a low-emissivity of less than or about 0.083. East/West facing windows may include a glazing comprising a solar heat gain coefficient of less than or about 0.330.

### BRIEF DESCRIPTION OF THE DRAWINGS

FIG. 1A is a top plan view of a first embodiment of a basement structure according to the present invention.

FIG. 1B is a top plan view of an embodiment of a form to be used to construct passageways under the basement floor of FIG. 1A.

FIG. 1C is a cutaway cross-sectional view taken along line 1C-1C in FIG. 7.

FIG. 2 is a top plan view of a first embodiment of a first floor structure according to the present invention.

FIG. 3 is a top plan view of a second embodiment of a basement structure according to the present invention.

FIG. 4 is a top plan view of a second embodiment of a first floor structure according to the present invention.

FIG. 5 is a top plan view of an embodiment of a second floor structure according to the present invention.

FIG. 6 is a front elevation view of an embodiment of a structure according to the present invention, including the basement structure of FIG. 1A, the first floor structure of FIG. 2, and the second floor structure of FIG. 5.

FIG. 7 is a cross-section elevation view of the structure of FIG. 6, taken along line 7-7 in FIG. 2.

FIG. 8 is a cross-section elevation view of the structure of FIG. 6, taken along line 8-8 in FIG. 2.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

Generally, a structure according to the present invention provides spaces having improved temperature stability. Around those spaces is provided a gas circulation path. In contact with at least a portion of the gas circulation path is a thermal mass. While the structure will be described as the front elevation preferably facing south and the back elevation preferably facing north, it is to be understood that variations in building placement are contemplated.

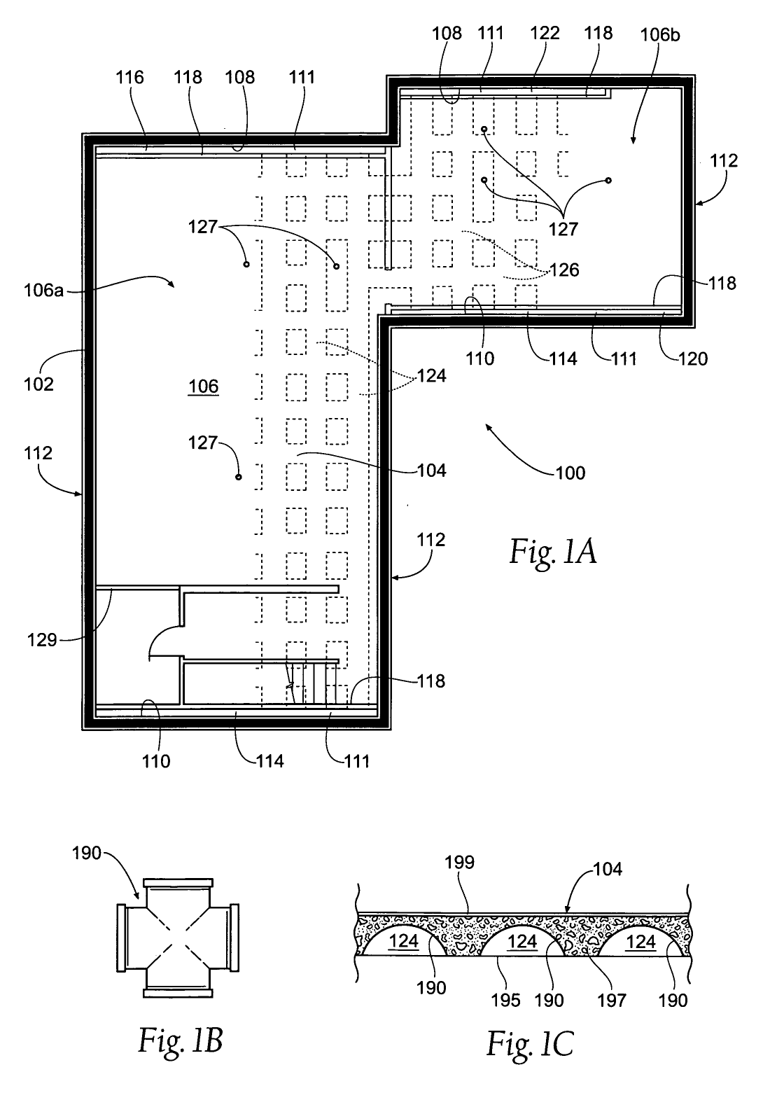

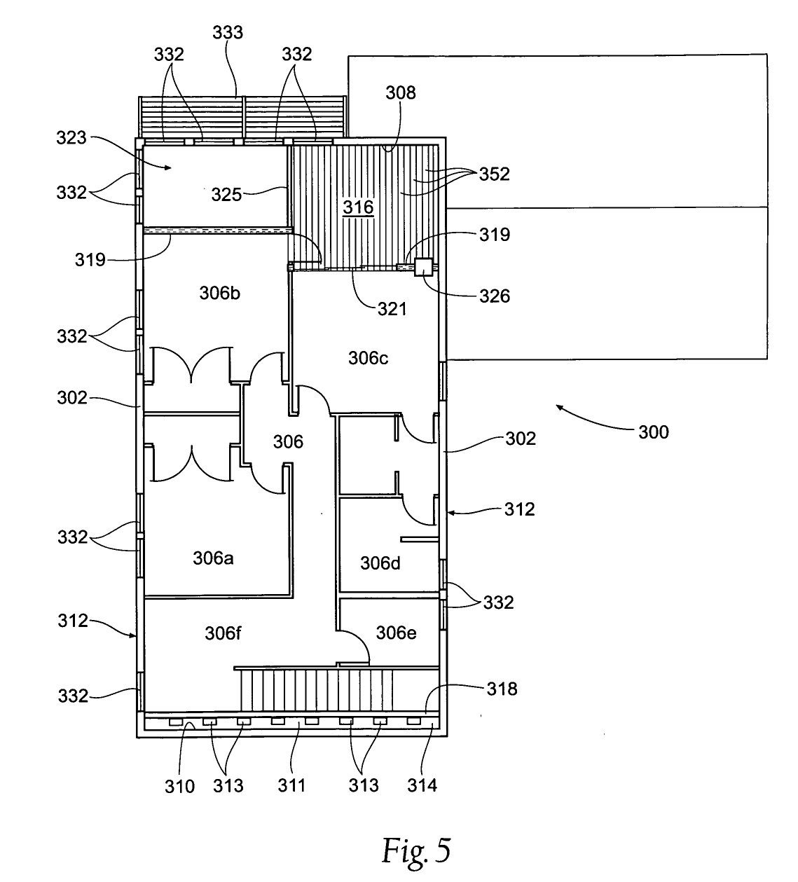

FIG. 1 provides a floor plan of a basement 100 that may be used in a structure according to the present invention. The basement 100 includes exterior walls 102 and a basement floor surface 104, which in combination define a basement space 106. The basement space 106 extends between a front end 108 and a back end 110, generally bounded by lateral basement sides 112. Along at least a portion of the back end 110, a first fluid flow duct 114 is provided. The first fluid flow duct 114 extends through the entire height of the basement space 106, as can be more fully seen in FIG. 5. Along at least a portion of the front end 108, a second fluid flow duct 116 is provided. The second fluid flow duct 116, like the first 114, extends through the entire height of the basement space 106. While various positions of the fluid flow ducts 114,116 may be established, the ducts 114,116 are preferably provided at and including their respective ends 110,108 of the basement space 106. The first duct 114 is not generally communicative with the second duct 116 through the basement space 106. The first duct 114 is preferably formed by a two-hour fire rated wall 118, which extends the height of the basement space 106, and the basement walls 102. The basement walls 102 preferably comprise a fourteen-inch thick insulated concrete foundation (ICF) wall, covered with a one-half inch thick gypsum board on the interior of the wall. The second duct 116 is preferably formed the same way as the first 114.

As shown, the front end 108 and the back end 110 of the basement space 106 may not be continuous surfaces between the lateral sides 112. That is, the basement space 106 may be laterally divided into two or more basement space sections 106a,106b by offset basement exterior walls 102. In such case, it may be desirable to provide separate fluid flow ducts for each section 106a,106b of the structure. For example, a third fluid flow duct 120 and a fourth fluid flow duct 122 may be provided towards the back end 110 and the front end 108, respectively, of the second basement space section 106b. As with the first 114 and second 116 ducts, the third 120 and fourth 122 ducts are preferably not generally communicative with any of the other ducts through the basement space 106. That is, the interior space 111 of each of the ducts 114,116,120,122 is at least substantially closed off from and not in fluid communication with the basement space 106.

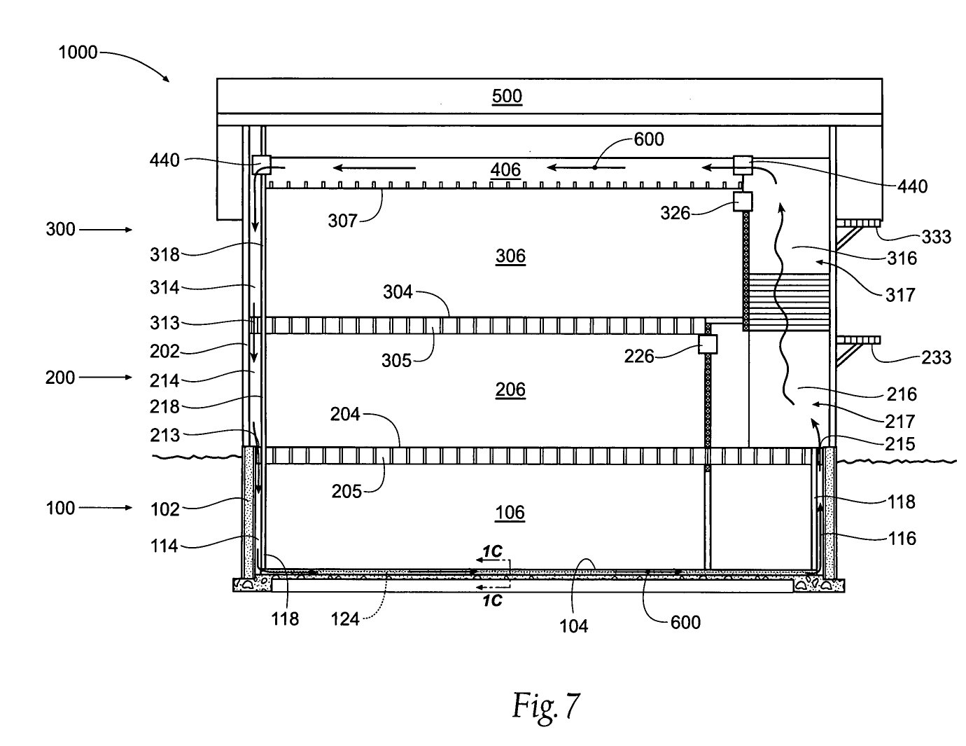

Under the basement floor surface 104, there is provided at least one fluid passageway 124, which places the first fluid flow duct 114 in fluid communication with the second fluid flow duct 116. Furthermore, there is provided at least one fluid passageway 126, which places the third fluid flow duct 120 in fluid communication with the fourth fluid flow duct 122. If a plurality of fluid passageways 124 are provided, they may be in fluid communication with each other. Likewise if a plurality of second passageways 126 are provided, they may be in fluid communication with each other. Furthermore, if desired, the first passageways 124 located under the first section 106a of the basement space 106 may be placed in fluid communication with the second passageways 126, which are located under the second section 106b of the basement space 106. While a plurality of pipes is one alternative for the passageways 124,126, a preferred method of forming the passageways 124,126 under the basement floor surface 104 is to utilize the Airfloor form system, which is made by Airfloor, Inc., of Lincolnshire, Ill. FIG. 1B is a top plan view of such a form 190, and FIG. 1C is a cross-section view taken along lines 1C-1C of FIG. 7, showing a plurality of the forms 190 cascaded and interconnected, which are supported by a subfloor 195, such as a structural floor. The forms 190 are then covered with, for example, a concrete material 197. The concrete 197 may provide the basement floor surface 104, or further flooring material 199, such as wood, vinyl, or carpet, may be applied over the concrete 195. By coupling the first duct 114 with the second duct 116 beneath the basement floor surface 104, one can avoid unsightly and cumbersome ductwork in the basement space 106. Furthermore, framed partition walls 129 can be placed in the basement space 106 without regard to airflow disturbances.

The basement 100 may be constructed from scratch at the final erection site, or may be provided in modular kit form to be constructed at the erection site; and, other common general building conventions may be followed, such as footings placed at desirable load locations, for example, footing placed beneath Lally columns 127 for support.

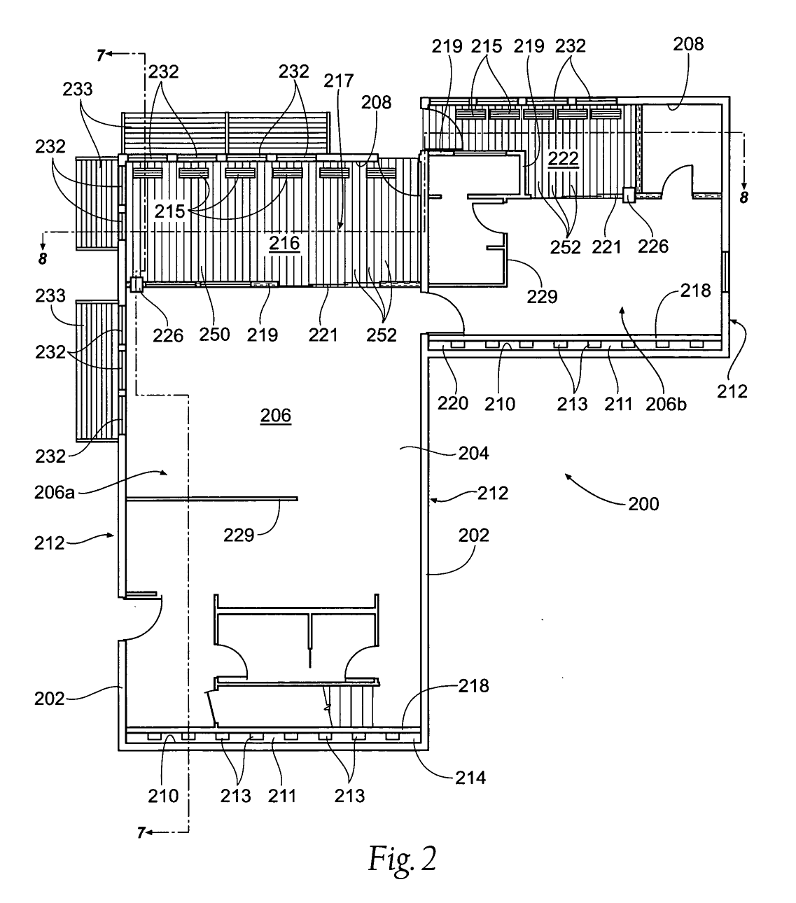

FIG. 2 provides a plan view of a first floor structure 200 to be situated atop a basement level, such as the basement 100 from FIG. 1. The first floor 200 includes exterior walls 202 and a floor surface 204, which in combination define a first living space 206. The first living space 206 extends between a front end 208 and a back end 210, generally bounded by lateral sides 212. Along at least a portion of the back end 210, a fifth fluid flow duct 214 is provided. The fifth fluid flow duct 214 extends through the entire height of the first living space 206, as can be more fully seen in FIG. 5, and is in fluid communication with the first fluid flow duct 114 in the basement 100, preferably through a plurality of joist ducts 213, which extend through the height of the first floor surface 204 and its supporting structure 205, as seen in FIG. 5. The joist ducts 213 are preferably formed as metallic sleeves that extend through the floor system 204,205.

Along at least a portion of the front end 208, a sixth fluid flow duct 216 is provided. The sixth fluid flow duct 216, like the fifth 214, extends through the entire height of the first living space 206. While various positions of the fluid flow ducts 214,216 may be established, the ducts 214,216 are preferably provided at and including their respective ends 210,208 of the first living space 206. The fifth duct 214 is not generally communicative with the sixth duct 216 through the first living space 206. The fifth duct 214 is preferably formed by a two-hour fire rated wall 218, which extends the height of the first living space 206, and the exterior walls 202. The exterior walls 202 preferably comprise six-inch thick, solid-core structural insulated panels (SIPs), such as those available from Energy Panel Structures Incorporated of Graettinger, Iowa. As is known in the art, SIPs are formed by sandwiching a layer of high performance rigid foam insulation, such as expanded polystyrene foam, or other insulation between a plurality of layers of plywood or oriented strand board (OSB).

The sixth duct 216 is preferably formed differently than the fifth duct 214. That is, the sixth duct 216 is preferably provided as sunspace 217 that has a fenestration including a plurality of windows 232, in at least one exterior wall 202, and further including a thermal mass 250. The thermal mass 250 has a thermal mass area that preferably includes all surfaces exposed to sunlight penetrating the windows 232. The thermal mass 250 is formed of a thermal mass material, such as southern yellow pine. The southern yellow pine may be glue laminated, or glulam, as is known in the art. A preferred thermal mass material includes southern yellow pine glulam logs 252 having cross-sectional dimensions of about five and one-half inches by about six and one-half inches, providing a cross-sectional area of about thirty-six square inches. The logs 252 may be stacked vertically or horizontally so as to cover the thermal mass area. Indeed, the back wall 219 of the sunspace 217 may be formed entirely from the southern yellow pine logs 232, thereby providing thermal mass and structural support. A first section 206a of the first living space 206 may be separated from the sunspace 217 by a sliding glass door 221.

As shown, the front end 208 and the back end 210 of the first living space 206 may not be continuous surfaces between the lateral sides 212. That is, the first living space 206 may be laterally divided into two or more sections 206a,206b by offset exterior walls 202. In such case, it may be desirable to provide separate fluid flow ducts for each section 206a,206b of the structure. For example, a seventh fluid flow duct 220 and an eighth fluid flow duct 222 may be provided towards the back end 210 and the front end 208, respectively, of the second living space section 206b. As with the fifth duct 214, the seventh 220 duct is preferably not generally communicative with any of the other ducts through the living space 206. That is, the interior space 211 of each of the fifth 214 and seventh 220 ducts is at least substantially closed off from and not in fluid communication with the living space 206.

However, the sixth duct 216 and the eighth duct 220 are preferably in selective fluid communication with the living space 206. Such selective communication may be provided simply by manual louvers (not shown), but is preferably automatically thermostatically, perhaps hysteretically, controlled. In-wall electric fans 226 are preferably disposed in the back wall 219 of each sunspace 216,222. The control of the fans 226 may be provided by a programmable controller (not shown), which controls one or more electrical relay switches (not shown) to switch electrical power to the fans 226 on and off. As is known in the art, a first temperature transducer, such as a first thermocouple, is operatively placed to measure the air temperature of the living space 206. A second temperature transducer, such as a second thermocouple, is operatively placed to measure the air temperature of the sunspace 217. The programmable controller is adapted to compare a first temperature indicated by the first temperature transducer to a first predetermined, or set, value, to determine whether the first temperature is below the set value by a cold-side hysteretic amount. The programmable controller is also adapted to compare a second temperature indicated by the second temperature transducer to the first temperature to determine whether the first temperature is less than the second temperature. If both conditions are true, that is, if the first temperature is below the set value by at least the cold-side hysteretic amount, and if the first temperature is less than the second temperature, the controller then controls the respective fan 226 to draw air from the associated sunspace 217 into the living space 206. In other words, if the air temperature of the living space 206 is below a predetermined temperature and the air temperature of the sunspace 217 is greater than the air temperature of the living space 206, then the warmer air from the sunspace 217 is drawn into the living space 206 by the fan 226. On the contrary, if the first temperature increases to or is above a first predetermined value, or if the second temperature decreases to or is below a second predetermined value, then the fan 226 is shut off or remains off, whichever may be the case. Similar logic may be employed to automatically control other mechanical operations in the structure, such as automated thermal drapery disposed on the inside of the structure 200 and adapted to aid in preventing heat loss through the windows 232, such as during the time between sunset and sunrise.

Also shown in FIG. 2 are sunshades 233, which extend outward from the exterior walls 202 of the first floor structure 200, over the windows 232 provided therein. The sunshades 233 are preferably fluted sunshades that allow sunlight to pass through the shades during desired times of the year, such as winter, while blocking the sun through other desired times of the year, such as summer. Although shown as relatively rigid, fluted sunshades, the sunshades 233 may also be comprised of retractable awnings (not shown) that are manually or automatically retractable. Such automatic retraction may be dependent upon desired thermostatic control.

The first floor structure 200 may be provided as a completed modular structure to be set atop a basement structure, or may be provided as and constructed from a kit directly atop the basement structure, such as the basement structure 100 of FIG. 1. Other common general building conventions may be followed, such as standard framing of non-loadbearing walls 229.

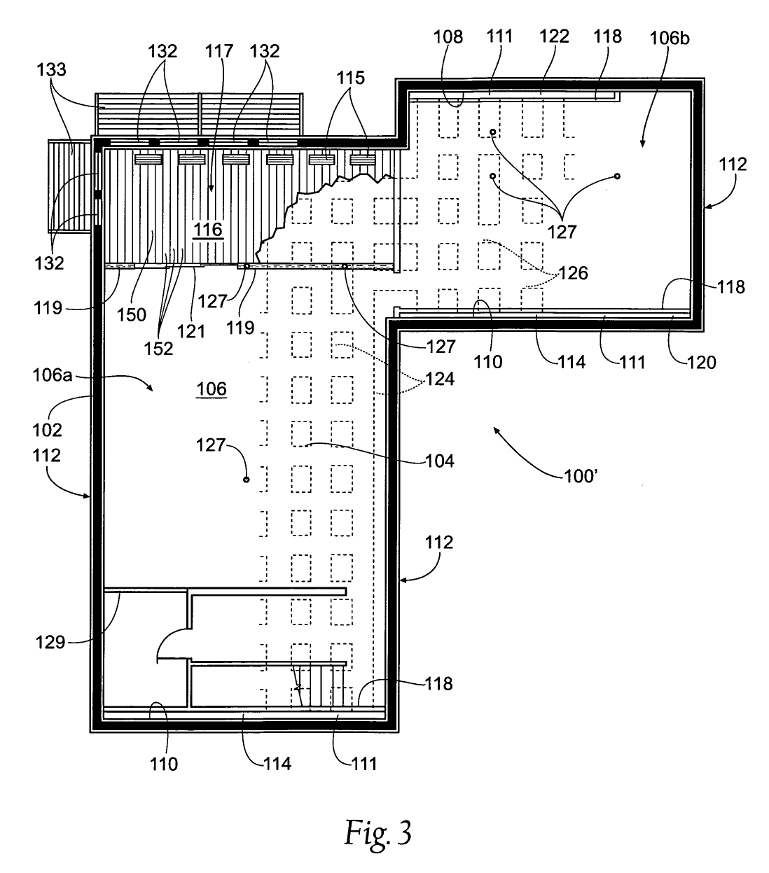

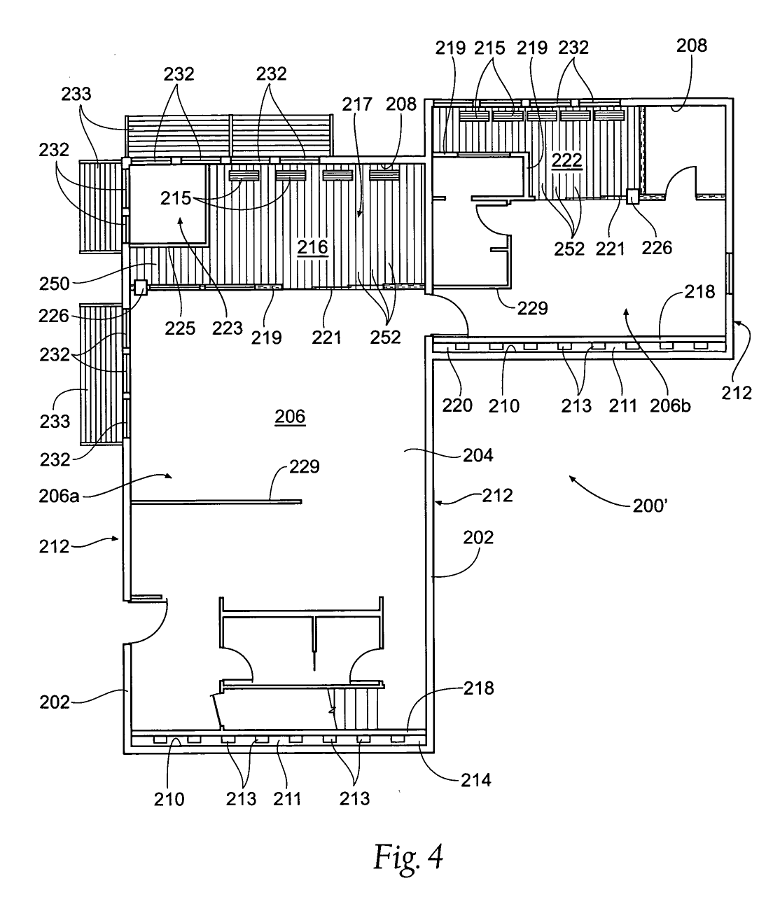

FIGS. 3 and 4 provide second embodiments of a basement structure 100′ and a first floor structure 200′ according to the present invention, respectively. In some locales, it may be desirable to include a basement structure 100′ that, like the first embodiment of a first floor structure 200, includes a basement sunspace 117, which provides additional solar collection and thermal mass and may provide slightly more efficient temperature control for the completed structure. In such case, the basement sunspace 117 is constructed substantially similar to the first embodiment of the first floor sunspace 217, including a thermal mass material 150, preferably comprising a plurality of southern yellow pine glulam logs 152, which are also stacked to form the back wall 119 of the sunspace 117. A sliding glass door 121 may provide physical access to the sunspace 117 from the basement space 106. Although the windows 132 are shown, the fenestration may include sliding glass doors (not shown), to provide the feature of a walk-out basement, if desired. Sunshades 133, which may be the same as or similar to the sunshades 233 described above, are suspended above the basement windows 132.

FIG. 4 provides the second embodiment of a first floor structure 200′. The construction of the second embodiment is substantially the same as the first 200, but further including a first sunspace duct 223, which cooperates with one or more floor ducts 115 to provide fluid communication between the sixth fluid flow duct 216 and the second fluid flow duct 116, allowing convection of warm air from the basement sunspace 117 through to the first floor sunspace 217. A railing 225 may be provided in the first floor sunspace 217 to provide a balcony overlooking the basement sunspace 117. The railing 225, itself, may be constructed of the thermal mass material 250.

While a structure according to the present invention may include only the basement 100 and the first floor 200, FIG. 5 provides a plan view of a second floor structure 300 to be situated atop a first floor structure, such as the first floor structure 200 from FIG. 2. The second floor 300 includes exterior walls 302 and a floor surface 304, which in combination define a second living space 306. The second living space 306 extends between a front end 308 and a back end 310, generally bounded by lateral sides 312. Along at least a portion of the back end 310, a ninth fluid flow duct 314 is provided. The ninth fluid flow duct 314 extends through the entire height of the second living space 306, as can be more fully seen in FIG. 5, and is in fluid communication with the fifth fluid flow duct 214 in the first living space 206, preferably through a plurality of joist ducts 313, which extend through the height of the first floor surface 304 and its supporting structure 305, as seen in FIG. 5. The joist ducts 313 are preferably formed as metallic sleeves that extend through the floor system 304,305.

Along at least a portion of the front end 308, a tenth fluid flow duct 316 is provided. The tenth fluid flow duct 316, like the ninth 314, extends through the entire height of the second living space 306. While various positions of the fluid flow ducts 314,316 may be established, the ducts 314,316 are preferably provided at and including their respective ends 310,308 of the second living space 306. The ninth duct 314 is not generally communicative with the tenth duct 316 through the second living space 306. The ninth duct 314 is preferably formed by a two-hour fire rated wall 318, which extends the height of the second living space 306, and the exterior walls 302. The exterior walls 302 preferably comprise six-inch thick, solid-core structural insulated panels (SIPs). As is known in the art, SIPs are formed by sandwiching a layer of high performance rigid foam insulation, such as expanded polystyrene foam, or other insulation between a plurality of layers of plywood or oriented strand board (OSB).

The tenth duct 316 is preferably formed differently than the ninth duct 314. That is, the tenth duct 316 is preferably provided as sunspace 317 that has a fenestration including a plurality of windows 332, in at least one exterior wall 302, and further including a thermal mass 350. The thermal mass 350 has a thermal mass area that preferably includes all surfaces exposed to sunlight penetrating the windows 332. The thermal mass 350 is formed of a thermal mass material, such as southern yellow pine. The southern yellow pine may be glue laminated, or glulam, as is known in the art. A preferred thermal mass material includes southern yellow pine glulam logs 352 having cross-sectional dimensions of about five and one-half inches by about six and one-half inches, providing a cross-sectional area of about thirty-six square inches. The logs 352 may be stacked vertically or horizontally so as to cover the thermal mass area. Indeed, the back wall 319 of the sunspace 317 may be formed entirely from the southern yellow pine logs 332, thereby providing thermal mass and structural support. Preferably, there is a second sunspace duct 323 that is open to the first floor sunspace 217, allowing convection of warm air from the first floor sunspace 217 to the second floor sunspace 317. A railing 325 may be provided in the second floor sunspace 317 to provide a balcony overlooking the first floor sunspace 217. The rest of the second level living space 306 may be separated from the sunspace 317 by a sliding glass door 321. The second level living space 306 may include a plurality of rooms, such as a plurality of bedrooms 306a,306b,306c, a plurality of bathrooms 306d,306e and a study or den area 306f. The fluid communication between the tenth and sixth fluid flow ducts may be provided through floor ducts (not shown) in addition to the sunspace duct 323.

The tenth duct 316 is preferably in selective fluid communication with the living space 306. Such selective communication may be provided simply by manual louvers (not shown), but is preferably automatically thermostatically, perhaps hysteretically, controlled. An in-wall electric fan 326 is preferably disposed in the back wall 319 of the sunspace 317. The control of the fan 326 is the same as or substantially similar to the control of the fans 226 described earlier, of course with temperature references to the third floor sunspace 317 and living space 306.

Also shown in FIG. 5 are sunshades 333, which extend outward from the exterior walls 302 of the second floor structure 300, over the windows 332 provided therein. The sunshades 333 are preferably fluted sunshades that allow sunlight to pass through the shades during desired times of the year, such as winter, while blocking the sun through other desired times of the year, such as summer. Although shown as relatively rigid, fluted sunshades, the sunshades 333 may also be comprised of retractable awnings (not shown) that are manually or automatically retractable. Such automatic retraction may be dependent upon desired thermostatic control.

As shown, the second living space 306 may be provided above only a section 206a of the first living space 206, or it may extend to cover the entire first living space 206. The second floor structure 300 may be provided as a completed modular structure to be set atop a first floor structure, or may be provided as and constructed from a kit directly atop the first floor structure, such as the first floor structure 100 of FIG. 2. Other common general building conventions may be followed, such as standard framing of non-loadbearing walls 329.

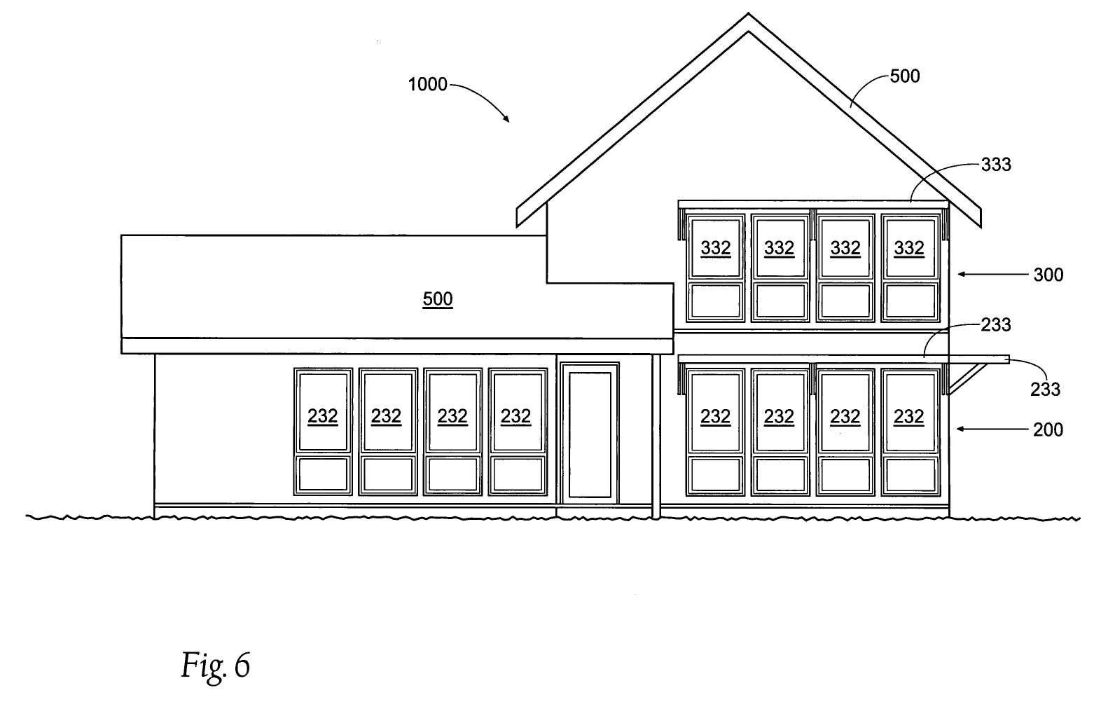

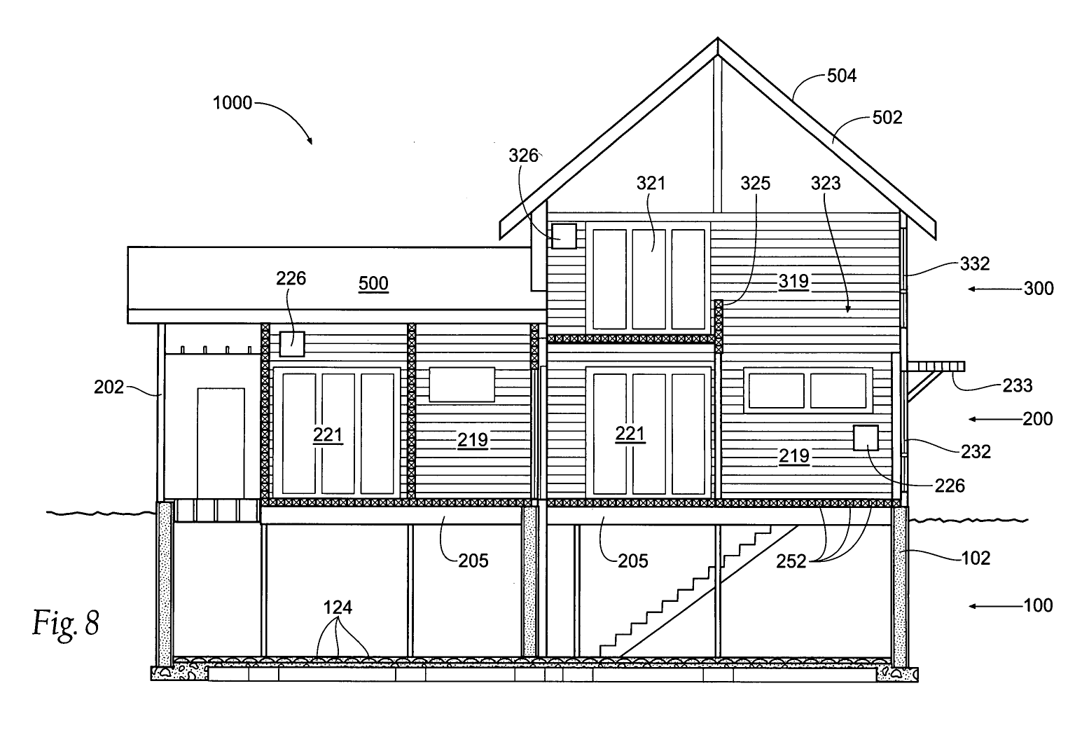

FIG. 6 shows a front elevation of a structure 1000 according to the present invention, wherein several of the windows 232,332 may be seen, thereby allowing light to pass into the respective sunspaces 217,317. The windows 232,332 that may be used are preferably selected based on the final erection site of the building 1000. That is, the specific glazings to be used are chosen at least partially based on the location of the building 1000. When a structure 1000 according to the present invention is constructed on a plot of land, the front end 108 of the basement 100 is preferably aimed directionally due South, and the structure assembled accordingly. The structure 1000 is particularly suited for location at or greater than thirty-two degrees North geographic latitude on Earth. The glazings used for the windows 232 provide desired solar receptivity. For instance, any windows 232,332 that face South preferably include a U factor of about 0.266 or lower, a solar heat gain coefficient of about 0.634 or higher, a solar transmittance of about 0.621 or higher and a low emissivity of about 0.083 or lower. Windows 232,332 that face directionally East or West preferably include a U factor of about 0.290 or lower and a solar heat gain coefficient of about 0.330 or lower. The solar transmittance and low emissivity ratings for the East/West windows 232,332 are thought to be of less criticality than the other parameters specified. Also in FIG. 6, the roof 500 of the structure 1000 can be seen. A preferred roof 500 is preferably formed from structural insulated panels (SIPs) 502, which are then covered with a desired roofing material 504, such as asphalt shingles, as seen in FIG. 8. Panels 502 are joined to the exterior walls 202,302 of the first floor structure 200 and the second floor structure 300, respectively, as is known in the art.

FIG. 7 is an illustrative cross-section showing a gas circulation path 600 beginning in the first floor sunspace 217, extending up through the second floor sunspace 317, which serves as the tenth fluid flow duct 316, and into an attic space 406 through a fire damper 440. A preferred fire damper 440 is a static fire damper that conforms to established standards, such as UL 555, and providing a preferred minimum air flow area of two square feet. The path 600 then preferably extends through the attic space 406, above the ceiling 307 of the second floor 300, and then down through the ninth fluid flow duct 314, the joist ducts 313, the fifth fluid flow duct 214, the joist ducts 213, and the first fluid flow duct 114. The path 600 then extends through the fluid passageways 124 under the basement floor surface 104, up through the second fluid flow duct 116, through the floor ducts 215 and back into the first floor sunspace 217 serving as the sixth fluid flow duct 216. A similar path exists beginning in the fourth fluid flow duct 222, extending up through a fire damper 440 and into an attic space (not shown) above the second living space 206b. The similar path then down through the seventh fluid flow duct 220, the joist ducts 213, and the third fluid flow duct 120. The similar path then extends through the fluid passageways 126 under the basement floor surface 104, up through the fourth fluid flow duct 122, through the floor ducts 215 and back into the eighth fluid flow duct 222. One or more of the ducts may be separated from the others by way of louvers or dampers. This may be desirable to control the rate of convection or other air flow, or the dampers may be provided to assist in controlling a fire, in case of emergency.

Not shown in any figure are some mechanical systems that aid in the temperature stability and efficiency of the structure 1000. For instance, though energy costs may be reduced, a standard thermostatically controlled furnace and/or an air conditioner may be required to maintain desired temperatures in the spaces 106,206,306 of the structure 1000. Where forced air ducts are utilized for heating/cooling, motorized dampers are preferably provided inline with the ductwork, preferably prior to each duct outlet vent. Alternatively, if other forms of heat are used, such as electric baseboard heat, each heater is preferably on a separate switchable circuit, thereby allowing selective control of the individual heaters. The motorized dampers and/or heating circuit switches can be logically controlled by a universal furnace thermostat, which receives indications of air temperature from temperature transducers, such as thermocouples, placed in desirable locations throughout the structure.

In addition to the mechanical heating and/or cooling systems, it may be desirable to include an energy recovery ventilator, also not shown in any of the drawings. The preferred ventilator is the Venmar AVS Energy Recovery Ventilator, model Duo 1.2, available from Venmar Ventilation Incorporated of Drummondville, Quebec, Canada. The ventilator acts as an air exchanger which keeps the internal spaces of the structure 1000 fresh, as it exchanges inside air with outside air, capturing energy as needed depending upon the season. The ventilator is ducted into both the interior living spaces of the structure, as well as the fluid flow ducts. The fluid communication of the ventilator air exchange with the ducts aids in controlling humidity in the ducts. The preferred ventilator has an air flow rating of preferably greater than about fifty cubic feet per minute and less than about one hundred and fifty cubic feet per minute, and more preferably about sixty cubic feet per minute to about one hundred and twenty cubic feet per minute.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A building structure comprising:
a basement structure including a basement space;
a first floor structure at least partially supported by said basement structure, said first floor structure including a first floor space;
a roof structure at least partially supported by said first floor structure; and
a fluid flow path extending beneath and through said basement space, through said first floor space, and below at least a portion of said roof structure,
wherein said fluid flow path may be selectively placed in and out of fluid communication with said first floor space.

2. A building structure according to claim 1, said basement structure further comprising:
at least one insulated concrete foundation (ICF) wall, said at least one ICF wall extending around at least a majority of said basement space.

3. A building structure according to claim 2, said basement structure further comprising:
said basement space including a basement front end, a basement back end, and a basement height;
a basement floor including a basement floor surface extending between a majority of the distance between said basement front end and said basement back end, said basement height extending substantially perpendicular to said basement floor; and
at least one fluid passageway extending beneath said basement floor surface between said basement front end and said basement back end.

4. A building structure according to claim 3, said basement structure further comprising:
a first fluid flow duct extending through said basement height, said first fluid flow duct being located closer to said basement back end than to said basement front end; and
a second fluid flow duct extending through said basement height, said second fluid flow duct being located closer to said basement front end than to said basement back end,
wherein said first fluid flow duct and said second fluid flow duct are at least substantially fluidly noncommunicative through said basement space; and
said first fluid flow duct and said second fluid flow duct are in fluid communication through said at least one fluid passageway;

5. A building structure according to claim 4, said basement floor comprising a poured concrete floor.

6. A building structure according to claim 5, said first floor structure further comprising:
at least one structural insulated panel (SIP) wall, said at least one SIP wall extending around a majority of said first floor space, wherein said first floor space includes a first floor front end, a first floor back end and a first floor height;
a fenestration at said first floor front end including a plurality of first floor front end windows;
a fifth fluid flow duct extending through said first floor height, said fifth fluid flow duct being located closer to said first floor back end than to said first floor front end;
a sixth fluid flow duct extending through said first floor height, said sixth fluid flow duct being located adjacent said first floor front end windows, wherein at least a portion of said sixth fluid flow duct is at least partially lined with a thermal mass material comprising southern yellow pine wood glue laminated logs, each of said logs having a cross-sectional area of about thirty-six square inches,
wherein said fifth fluid flow duct and said sixth fluid flow duct are at least substantially fluidly noncommunicative through said first floor space,
wherein said fifth fluid flow duct and said first fluid flow duct are in fluid communication and said sixth fluid flow duct and said second fluid flow duct are in fluid communication,
wherein said fifth fluid flow duct may be selectively placed in and out of said fluid communication with said first floor space, and
wherein an electric fan is positioned inline with said fluid communication between said fifth fluid flow duct and said first floor space, adapted to draw air from said fifth fluid flow duct and blow said air into said first floor space.

7. A building structure according to claim 6, said roof structure further comprising:
at least one structural insulated panel (SIP), said at least one SIP at least partially defining an attic space,
wherein said fifth fluid flow duct and said sixth fluid flow duct are in fluid communication through said attic space,
and further wherein at least one fire damper is disposed between said fifth fluid flow duct and said sixth fluid flow duct.

8. A building structure according to claim 7, further comprising a sunshade extending from an external wall of said first floor structure, above said windows.

9. A building structure according to claim 8, said sunshade adapted to obstruct a majority of sunlight that strikes said sunshade during a first portion of a calendar year and further adapted to obstruct a minority of sunlight that strikes said sunshade during a second portion of a calendar year.

10. A building structure according to claim 8, said windows comprising glazings having a U factor of less than or about 0.290.

11. A building structure according to claim 10, wherein at least one of said windows including a glazing comprises:
a U factor of less than or about 0.266;
a solar heat gain coefficient of greater than or about 0.634;
a solar transmittance of greater than or about 0.621; and
a low-emissivity of less than or about 0.083.

12. A building structure according to claim 11, wherein at least another one of said windows includes a glazing comprising a solar heat gain coefficient of less than or about 0.330.

13. A building structure according to claim 1, said roof structure further comprising:
at least one structural insulated panel (SIP), said at least one SIP at least partially defining an attic space;
wherein said fluid flow path extends through said attic space.

14. A building structure according to claim 1, said first floor structure further comprising:
at least one structural insulated panel (SIP) wall, said at least one SIP wall extending around a majority of said first floor space, wherein said first floor space includes a first floor front end, a first floor back end and a first floor height.

15. A building structure according to claim 14, said first floor structure further comprising:
a fenestration at said first floor front end including a plurality of first floor front end windows;
a fifth fluid flow duct extending through said first floor height, said fifth fluid flow duct being located closer to said first floor back end than to said first floor front end;
a sixth fluid flow duct extending through said first floor height, said sixth fluid flow duct being located adjacent said first floor front end windows, wherein at least a portion of said sixth fluid flow duct is at least partially lined with a thermal mass material;
said fifth fluid flow duct and said sixth fluid flow duct being at least substantially fluidly noncommunicative through said first floor space;

16. A building structure according to claim 15, said thermal mass material comprising wood.

17. A building structure according to claim 16, said thermal mass material comprising southern yellow pine.

18. A building structure according to claim 17, said thermal mass material comprising southern yellow pine glue laminated logs.

19. A building structure according to claim 18, each of said logs having a cross-sectional area of about thirty-six square inches.

20. A method comprising the steps of:
providing a building structure according to claim 12;
positioning said first floor front end towards at least a substantially due South direction.

21. A method according to claim 20, said method further comprising the step of locating said building structure at or above the thirty-second geographic parallel.
